(19) United States
(12) Patent Application Publication
(10) Pub. No.: US 2004/0103683 A1
(43) Pub. Date: Jun. 3, 2004

(54) Suction muffler for compressor

(76) Inventor: Min-Chol Yoon, Gwangju-city (KR)

Correspondence Address: Todd S. Parkhurst, Holland & Knight LLC, 30th Floor, 131 South Dearborn st., Chicago, IL, 60603, US

(21) Appl. No.: 10/672,986

(22) Filed: Sep. 26, 2003

(30) Foreign Application Priority Data
Nov. 28, 2002 (KR) 2002-74815

(51) Int. Cl. F02M 35/00; F25D 19/00; F04B 39/00; F04B 53/00

(52) U.S. Cl. 62/296; 181/229; 417/312

(57) ABSTRACT

The suction muffler of a reciprocating compressor according to the disclosed invention comprises a flow controller for controlling the flow of refrigerant so that a steady amount of refrigerant flows into the suction port of the suction muffler. The flow controller comprises a fixing member having a main refrigerant path, a plurality of refrigerant sub-paths formed to vertically penetrate the fixing member along and adjacent to a circumference of the main refrigerant path at predetermined intervals, and a space with a diameter larger than an imaginary circle made by connecting the plurality of refrigerant sub-paths, formed under the main refrigerant path and the plurality of refrigerant sub-paths. A movable member has a first through hole formed to correspond to the main refrigerant path, and a plurality of second through holes formed at predetermined intervals on the imaginary circumference having a diameter larger than an imaginary circle made by connecting the plurality of refrigerant sub-paths. This movable member is disposed to move between a first location for closing the plurality of refrigerant sub-paths and a second location for opening the plurality of refrigerant sub-paths. A resilient member resiliently urges the movable member towards the second location. Accordingly, a steady amount of refrigerant flows in and out of the suction muffler and therefore noises can be reduced and unstable load in the valve system can be prevented.

### BACKGROUND OF THE INVENTION

1. Field of the Invention

The present invention relates to a compressor, and more particularly to a suction muffler for a reciprocating compressor.

2. Description of the Prior Art

Generally, a compressor is used for compressing low-pressure refrigerant gas, which has evaporated in a refrigerating system of an air conditioner or a refrigerator, into high pressure and temperature as a part of the refrigerating cycle of continuous compression, condensation, expansion and evaporation of the refrigerant.

FIG. 1 shows a reciprocating compressor as an example of the above-described compressor.

As shown in FIG. 1, in a general reciprocating compressor, a motor 2 provided in a casing 1 rotates a crank shaft 3 thereby driving a connecting rod 4 disposed on an eccentric portion 3a, and accordingly a piston 5 disposed at the leading end of the connecting rod 4 reciprocates a predetermined number of strokes inside a cylinder 6. When the piston 5 moves from the top dead center to the bottom dead center, a discharge valve of a valve system 7 is closed and at the same time a suction valve is opened, and therefore gas refrigerant flows into the cylinder 6 from a suction pipe 8. When the piston 5 is moved from the bottom dead center to the top dead center, the refrigerant is compressed, and after the refrigerant is compressed, the discharge valve 7 is opened and the compressed refrigerant is discharged through the discharge pipe.

A suction muffler 10 in such reciprocating compressor and refrigeration system is provided in order to reduce noise generated as the refrigerant is sucked in. Such suction muffler 10 is disposed at the entrance of the cylinder 6 as shown in FIG. 1, and accordingly the refrigerant from an evaporator (not shown) flows into the cylinder 6 through the suction muffler 10.

As shown in FIG. 2, the suction muffler 10 has a suction port 12, into which the suction pipe 8 is connected at a side of a muffler body 11, and a discharge port 13 is formed at a predetermined distance interval from the suction port 12. Formed at another side of the muffler body 11 is a resonator 14, and formed between the suction port 12 and the discharge port 13 are first and second refrigerant paths 16, 17 provided for refrigerant to flow through. The discharge port 13 has a muffler base 20 inducing the refrigerant to flow into the cylinder 6.

The suction muffler 10 of a general reciprocating compressor structured as described above is disposed to have the suction port 12 connected with the suction pipe 8, and the muffler base 20 connected with the cylinder 6. The refrigerant flows into the muffler body 11 through the suction port 12 and is discharged to the discharge port 13 via the first and second refrigerant paths 16, 17. During that refrigerant flow activity, noises are reduced by the resonator 14. The refrigerant discharged to the discharge port 13 is flows into the cylinder 6 through the muffler base 20.

However, in the suction muffler 10 of a general reciprocating compressor described above, the refrigerant flows in through the suction port 12 to the discharge port 13, and then through the first and second refrigerant paths 16, 17 forming a steady refrigerant flow path as shown by the arrows in the drawing. But the amount of the refrigerant discharged to the discharge port 13 is unstable because the amount and flow velocity of the refrigerant flowing in through the suction port 12 varies.

Moreover, turbulence may occur in the flow of the refrigerant out from the evaporator in the refrigerating cycle due, for example, to the pulsation occurring at the beginning of the operation of the refrigerant recycle. Due to such turbulence events, the amount and flow velocity of the refrigerant flowing in through the suction port 12 of the suction muffler 10 may vary. However, since there are no devices or structure employed for buffering such turbulences in the conventional suction muffler 10, the change in the amount and flow velocity of the refrigerant at the suction port 12 directly causes the amount of refrigerant discharged to the discharge port 13 to be unsteady.

Unsteady amount of the refrigerant being discharged through the discharge port 13 causes abnormal operation of valves, thereby causing noises and decreasing the effectiveness of compression at the beginning of the cycling operation or during the cycling operation.

### SUMMARY OF THE INVENTION

An object of the invention is to solve the above problems and to provide the advantages described hereinafter.

Accordingly, one object of the present invention is to solve the foregoing problems by providing a suction muffler for a reciprocating compressor which is capable of controlling the amount of refrigerant flowing into the suction muffler. A related object is to provide mechanism to steady the amount and velocity of refrigerant flowing from an evaporator, which would otherwise vary due to the turbulence caused by external factors.

The foregoing and other objects and advantages are realized by providing a suction muffler of a reciprocating compressor comprising a muffler body having a suction port connected to a refrigerant suction pipe, a discharge port, and a resonator, a muffler base connected to the discharge port for inducing refrigerant discharged through the discharge port to flow into a cylinder, and a flow controller disposed in the suction port for controlling and steadying the flow of refrigerant to the suction port.

The flow controller comprises a fixing member having a main refrigerant path, a plurality of refrigerant sub-paths formed to vertically penetrate the fixing member along and adjacent to the circumference of the main refrigerant path at predetermined intervals. The controller also includes a space which has a diameter larger than an imaginary circle made by connecting the plurality of refrigerant sub-paths. This space is formed under the main refrigerant path and the plurality of refrigerant sub-paths. A movable member has a first through hole formed to correspond to the main refrigerant path, and a plurality of second through holes, formed at predetermined intervals on the imaginary circumference having a diameter larger than a imaginary circle made by connecting the plurality of refrigerant sub-paths, are disposed in the space of the fixing member to move to a first location for closing the plurality of refrigerant sub-paths and a second location for opening the plurality of refrigerant sub-paths. A resilient member resiliently supports the movable member and biases it towards the second location.

The movable member comprises a guide with the outer circumferential surface sliding and touching the inner circumferential surface of the main refrigerant path, the guide formed with the first through hole, and a disk of a predetermined thickness with the outer circumferential surface sliding and touching the inner circumferential surface of the space, the disk being formed with a plurality of through holes.

In addition, the movable member is maintained at the second location by being supported by the suction pipe connected to the suction port. The movable member rises and moves to the first location when an excessive amount of refrigerant flows in.

In this embodiment of the invention, the resilient member is a compression coil spring disposed in the main refrigerant path.

Accordingly, a relatively steady amount of refrigerant always flows in and out of the suction muffler and therefore noises can be reduced and unstable load in the valve system can be prevented.

### BRIEF DESCRIPTION OF THE DRAWINGS

The above objects and features of the present invention will be more apparent by describing a preferred embodiment of the present invention with reference to the accompanying drawings, in which:

FIG. 1 is a sectional view schematically showing a conventional reciprocating compressor;

FIG. 2 is a sectional view showing structure and operation of a suction muffler of a conventional reciprocating compressor;

FIG. 3 is a sectional view showing a suction muffler of a reciprocating compressor according to an embodiment of the present invention;

FIG. 4 is a perspective view showing a flow controller embodying the present invention;

FIG. 5 is a partial sectional view illustrating the inner structure of the flow controller shown in FIG. 4; and

FIGS. 6 and 7 are partial sectional views for describing the operation of the flow controller embodying the present invention.

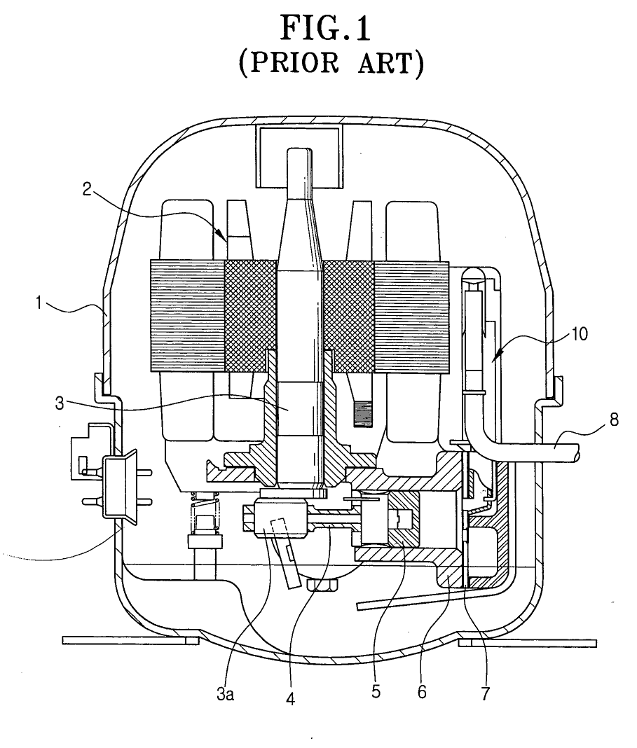

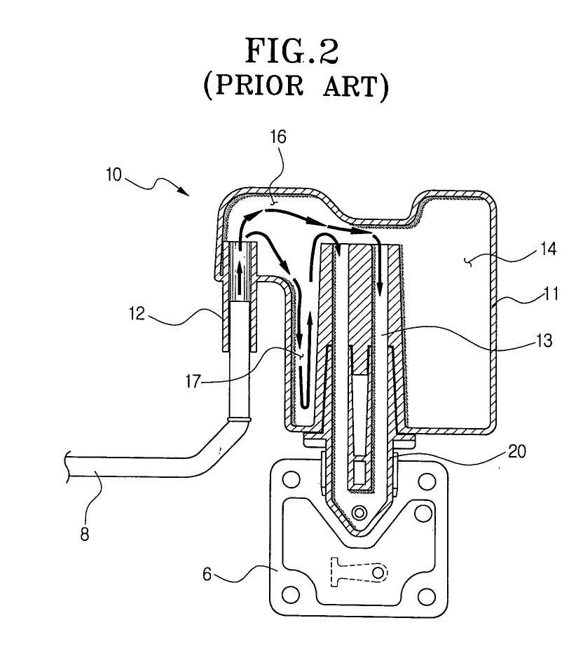

### DETAILED DESCRIPTION OF THE PREFERRED EMBODIMENT

Hereinafter, a suction muffler of a reciprocating compressor according to a preferred embodiment of the present invention will be described in greater detail with reference to the accompanying drawings. With respect to the elements identical to those of the prior art, like reference numerals refer to those like parts.

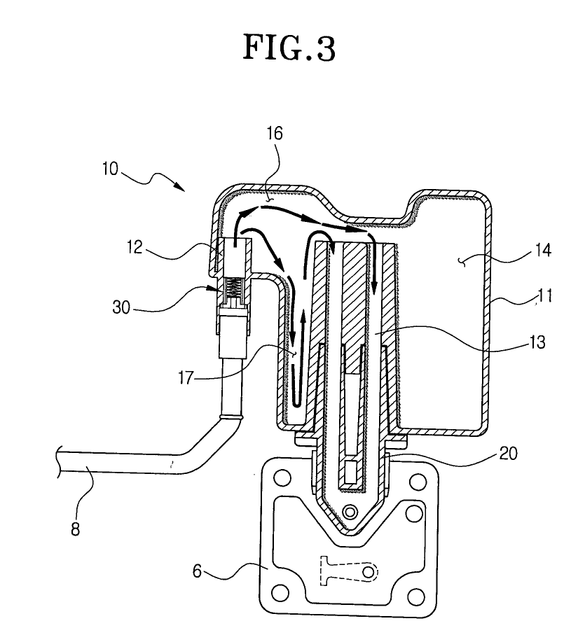

As shown in FIG. 3, the suction muffler 10 of a reciprocating compressor according to an embodiment of the present invention comprises a muffler body 11, a muffler base 20, and a flow controller 30.

The muffler body 11 has a suction port 12 connected to a suction pipe 8 located at a muffler first side, and a discharge port 13 at a predetermined interval or distance from the suction port 12. In addition, the muffler body 11 has a resonator 14 formed at the other side of the muffler, and first and second refrigerant paths 16, 17 are formed between the suction port 12 and the discharge port 13 to provide a passage for refrigerant flowing in through the suction port 12.

The muffler base 20 has an end connected to the discharge port 13 of the muffler body 11 and another end connected to the cylinder 6. Accordingly, the refrigerant discharged through the discharge port 13 flows into the cylinder 6 through the muffler base 20.

The flow controller 30 is disposed at the suction port 12 to control the flow of refrigerant so that the amount or rate of refrigerant flowing in through the suction port 12 is always steady. Due to the flow controller 30, only an appropriate amount of refrigerant can flow into the suction muffler 10 even if an excessive amount of refrigerant flows to the suction port 12. This flow control prevents various problems caused by excessive flow of refrigerant.

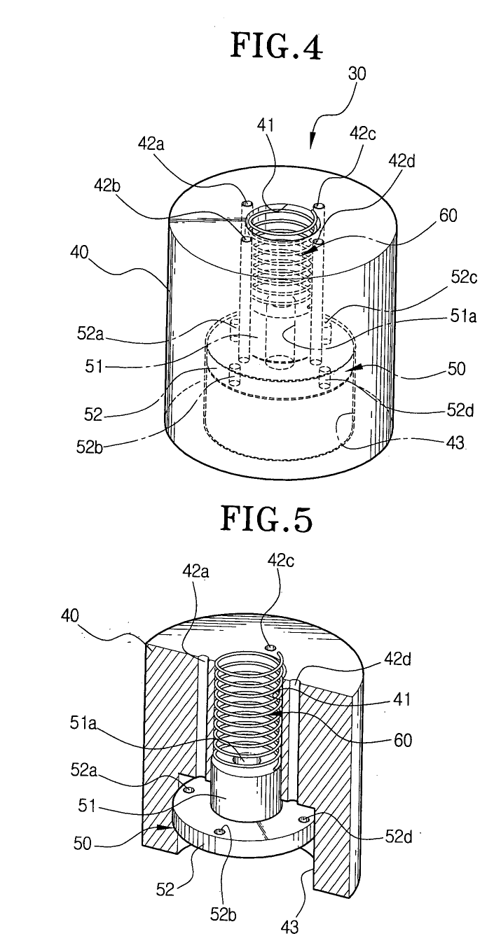

This flow controller 30 comprises a fixing member 40, a movable member 50, and a resilient member 60 as shown in FIGS. 4 and 5.

The fixing member 40 has an exterior structure comprising a cylinder of predetermined height which is fixed inside the suction port 12. The fixing member 40 defines a main refrigerant path 41, a plurality of refrigerant sub-paths 42a, 42b, 42c, 42d (hereinafter collectively referred to as 42 only), and a space 43. The main refrigerant path 41 is formed to vertically penetrate the center portion of the fixing member 40 and the plurality of refrigerant sub-paths 42 are formed to vertically penetrate the fixing member 40 along and adjacent to the circumference of the main refrigerant path 41 at predetermined intervals. The space 43 has a diameter larger than an imaginary circle made by connecting the plurality of refrigerant sub-paths 42 and is formed under the main refrigerant path 41 and the plurality of refrigerant sub-paths 42. The main refrigerant path 41 and the plurality of refrigerant sub-paths 42 of the fixing member 40 allow refrigerant to flow into the suction muffler 10 through the suction port 12.

The movable member 50 is adapted to control the flow of refrigerant through the main refrigerant path 41 and the plurality of refrigerant sub-paths 42 of the fixing member 40. In particular, when an excessive amount of refrigerant flows to the suction port 12, the movable member 50 blocks the plurality of refrigerant sub-paths 42 thereby allowing the flow of refrigerant only through the main refrigerant path 41.

This movable member 50 is disposed in the space 43 of the fixing member 41 so as to move between a first location and a second location, and it comprises a guide 51 and a disk 52 of a predetermined thickness. The outer circumferential surface of the guide 51 slides and touches the inner circumferential surface of the space 43. A first through hole 51a corresponding to the main refrigerant path 41 is formed to vertically penetrate the center portion of the guide 51, and a plurality of second through holes 52a, 52b, 52c, 52d (hereinafter collectively referred to as 52 only) corresponding to the plurality of refrigerant sub-paths 42 are formed vertically near the edge of the disk 52.

The plurality of second through holes 52 are formed at predetermined intervals on the imaginary circumference of a circle having a diameter larger than an imaginary circle made by connecting the plurality of refrigerant sub-paths 42.

The first location is illustrated in FIG. 7 in which the movable member 50 has been moved up to the highest part of the space 43, and the disk 52 is in contact with the ceiling of the space 43 thereby closing the plurality of refrigerant sub-paths 42. The second location is illustrated in FIG. 6 in which the movable member 50 has been moved down and the plurality of through holes 52 of the disk 52 and the plurality of refrigerant sub-paths 42 are connected. The main refrigerant path 41 is always open when movable member 50 is either in the first location or in the second location.

Accordingly, when the movable member 50 is in the first location, refrigerant flows only through the main refrigerant path 41. When the movable member 50 is in the second location, refrigerant flows through the main refrigerant path 41 and the plurality of refrigerant sub-paths 42. The movable member 50 maintains its position in the second location by being supported by the suction pipe 8 connected to the suction port 12 as shown in FIG. 6.

The resilient member 60 resiliently biases the movable member 50 towards the second location. Here, the resilient member 60 is a compressed coil spring disposed in the main refrigerant path 41 in the embodiment, but the resilient member 60 is not limited to any particular type and may have any other forms such as, for example, a tension coil spring disposed under the movable member 50.

The resilient member 60 applies a tensile force equal to the force of the pressure of the inflowing refrigerant in an amount which is determined to be appropriate. Accordingly, when the appropriate amount of refrigerant flows in, the movable member 50 is maintained at the second location by the tension of the resilient member 60, but when an excessive amount of refrigerant flows in, the resilient member 60 contracts because of the pressure of the inflowing refrigerant. Consequently, the movable member 50 moves to the first location.

The operation of the flow controller 30 according to the present invention as described above will be described hereinafter referring to FIGS. 6 and 7.

FIG. 6 is a partial sectional view showing the flow controller 30 when an appropriate amount of refrigerant is flowing. As shown, the movable member 50 is in the second location and accordingly, the plurality of refrigerant sub-paths 42 and the plurality of second through holes 52 of the movable member 50 are connected, and the refrigerant flows into the suction muffler 10 through the main refrigerant path 41 and the plurality of refrigerant sub-paths 42. The movable member 50 does not change its location unless the amount and flow velocity increases, because the tension of the resilient member 60 is set to have a force equal to the pressure of the inflowing refrigerant. The arrows in the drawing show flow of the refrigerant.

When the amount of refrigerant flow increases due to external reasons—for example, initial operation of the compressor—the amount and flow velocity of the refrigerant flowing into the suction port 12 increases, and accordingly the pressure of the inflowing refrigerant also increases thereby allowing the movable member 50 to move upward overcoming the tension of the resilient member 60. Therefore, the movable member 50 moves to the first location in contact with the ceiling of the space 43 as shown in FIG. 7. Accordingly, in this configuration, the plurality of refrigerant sub-paths 42 are blocked by the disk 52 of the movable member 50 and the refrigerant flows only through the main refrigerant path 41.

Alternatively, when the amount of refrigerant flowing at the suction port 12 is stabilized, the movable member 50 is dropped by the tension of the resilient member 60 to the second location, and the refrigerant flows through the main refrigerant path 41 and the plurality of refrigerant sub-paths 42.

The suction muffler of a reciprocating compressor equipped with the flow controller according to the present invention can have the amount of refrigerant flowing into the suction muffler through the suction port automatically controlled and steadied in accordance with the amount and flow velocity of the refrigerant at the suction port. Therefore, the problems caused by unstable refrigerant flow are obviated.

According to the invention described above, pulsation occurring in the flow of refrigerant at the suction port can be reduced since the amount of refrigerant flowing into the suction port of the suction muffler can always be maintained in a relatively steady pressure and flow. Moreover, unstable loads in the valve system can be prevented. As a result, noises and abnormal operation due to unstable load in the valve system do not occur.

According to the present invention, a quiet compressor can be provided and product competitiveness and satisfaction can be increased.

The foregoing embodiments and advantages are merely exemplary and are not to be construed as limiting the present invention. The present teaching can be readily applied to other types of apparatus. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A suction muffler of a reciprocating compressor comprising:
a muffler body having a suction port connected to a refrigerant suction pipe, a discharge port, and a resonator;
a muffler base connected to the discharge port for inducing refrigerant discharged through the discharge port to flow into a cylinder; and
a flow controller disposed in the suction port for controlling and steadying flow of refrigerant into the suction port.

2. The suction muffler of a reciprocating compressor according to claim 1 wherein the flow controller comprises:
a fixing member having a main refrigerant path, a plurality of refrigerant sub-paths formed to vertically penetrate the fixing member along and adjacent to the main refrigerant path at predetermined intervals, and a space with a diameter larger than an imaginary circle made by connecting the plurality of refrigerant sub-paths, formed under the main refrigerant path and the plurality of refrigerant sub-paths;
a movable member having a first through hole formed to correspond to the main refrigerant path, and a plurality of second through holes formed at predetermined intervals on the imaginary circumference having a diameter larger than an imaginary circle made by connecting the plurality of refrigerant sub-paths, disposed in the space of the fixing member to move between a first location for closing the plurality of refrigerant sub-paths and a second location for opening the plurality of refrigerant sub-paths; and
a resilient member resiliently supporting the movable member and biasing that member towards the second location.

3. The suction muffler of a reciprocating compressor according to claim 2, wherein the movable member comprises a guide with the outer circumferential surface sliding and touching the inner circumferential surface of the main refrigerant path, the guide formed with the first through hole, and a disk of a predetermined thickness with the outer circumferential surface sliding and touching the inner circumferential surface of the space, the disk formed with a plurality of through holes.

4. The suction muffler of a reciprocating compressor according to claim 3, wherein the movable member is supported by the suction pipe connected to the suction port, and rises and moves toward the first location when an excessive amount of refrigerant flows in.

5. The suction muffler of a reciprocating compressor according to claim 2, wherein the resilient member is a compression coil spring disposed in the main refrigerant path.
